(19) United States
(12) Patent Application Publication
(10) Pub. No.: US 2026/0210101 A1
(43) Pub. Date: Jul. 23, 2026

(54) Cleaning device for cleaning toilets

(71) Applicant: Abdullah SIT, Bergheim (DE)

(72) Inventor: Abdullah SIT, Bergheim (DE)

(21) Appl. No.: 19/031,534

(22) Filed: Jan. 18, 2025

(51) Int. Cl. E03D 9/08; B05B 15/20; B05B 15/40

(52) U.S. Cl. CPC E03D 9/085; B05B 15/20; B05B 15/40

(57) ABSTRACT

The invention relates to a device for cleaning toilets, the device at least partly consisting of antibacterial plastics, the device having: a hose connectable to a water supply in order to supply water for the device via the hose, a handle fastened to the hose, the handle comprising a water regulator for adjusting a water inlet into the device via the water regulator, a pipe arranged downstream on the handle, the pipe having a filtering system arranged therein, the filtering system dividing the pipe into a constant cross-section upstream portion and a downstream portion tapering downstream, the upstream portion forming a mixing chamber for receiving a fragrance or a cleansing agent and the downstream portion being adapted to accelerate the water flowing out from the mixing chamber; the downstream portion having a nozzle at its outlet, the handle and the pipe being embodied rotationally symmetrical along a common axis.

### TECHNICAL FIELD

The present invention relates to a cleaning device for cleaning toilets (also called toilet cleaning device) according to Claim 1 which is generally rod-shaped.

### BACKGROUND AND STATE OF THE ART

As a rule, a conventional toilet brush consists of an inflexible plastic handle with a brush head. Even the models with a lateral rim cleaner do not reach all areas of the toilet. This results in hygienically insufficient cleaning of both the toilet bowl and the rim. Even with thorough cleaning, germs, bacteria and the well-known and dangerous colibacilla demonstrably remain which can cause infectious diseases. Cleaning with a conventional toilet brush takes place by bending the upper body forward, wherein the face of the cleaning staff is so closely bent over the toilet bowl that drops of spray water reach the face and skin during cleaning. During use of this brush, it is not uncommon to find paper shreds from previous use (at the least) in the brush head. Frequently, the brush is lifted from a container in which water with large numbers of germs has accumulated. Before the brush reaches the toilet bowl for cleaning, generally a few drops fall on the toilet seat, forming a breeding ground for bacteria. This is not in keeping with the 21^{st} century.

In conventional cleaning with the traditional toilet brush, generally it is attempted, using large amounts of cleaners, to reach, if possible, all areas under the toilet rim and in the drain elbow, above and, even more importantly, under water. This is due to the fact that these are the areas with increased deposits of urine scale, bacteria and germs.

According to the Bundesinstitut für Bevölkerungsforschung (German institute for population research), Germany alone has around 41 million households in which 2 people live. This does not include large families, single households, schools, hospitals or other public facilities such as restaurants. Starting from these 41 million households that each of them disposes of the set of brushes every 6 months, plastic waste of 8,200 tons results, calculating with an average of 200 grams. This rough estimation does not even include the packaging material and the release of CO₂ and particulate matter during delivery.

In highway toilets, hospitals and many other public facilities, it is common today for the toilet seat to be completely circulated and disinfected after each toilet visit. Non-contact fittings, soap dispensers electronic hand dryers can be found there. Even the light is automatically switched on by motion detectors; only the toilet brush is still positioned in a corner that no one really wants to come in contact with.

### OBJECT AND SUMMARY OF THE INVENTION

The object of the present invention is therefore to at least partially overcome the above-mentioned drawbacks of the state of the art and to provide a cleaning device for toilets which effectively cleans a toilet with usage of a fragrance and/or a cleansing agent. A constant and unimpeded flow of water mixed with fragrance and/or cleansing agent is to be guaranteed.

This object is achieved by means of a cleaning device having the features of Claim 1.

Advantageous embodiments are described in the dependent Claims.

In particular, the object is achieved by means of a cleaning device for cleaning toilets, the cleaning device at least partly, preferably completely, consisting of antibacterial plastics. The cleaning device has the following features: a hose connectable to a water supply in order to supply water for the cleaning device via the hose. A handle fastened to the hose, the handle further comprising a water regulator for adjusting an inlet of water into the cleaning device. A tube arranged on the handle, the tube having a filtering system arranged inside the tube. The handle and the tube are formed rotationally symmetrical along a common axis. The filtering system divides the tube into an upstream portion with a substantially constant cross-section and a downstream portion tapering in the downstream direction. The upstream portion forms a mixing chamber for accommodating a fragrance or a cleansing agent and the downstream portion is adapted to accelerate the fragrance or cleansing agent mixed with water. The downstream portion further has a nozzle at its outlet. The filtering system preferably comprises a sieve arranged in a sieve bed, the sieve bed securely retaining the sieve and also facilitating replacement of the sieve.

Conceptually the following should be explained hereto:

It is explicitly pointed out that in the context of the present patent application, indefinite articles and indefinite numerals, such as “one . . . ”, “two” etc., are normally to be understood as indicating a minimum, that is, “at least one . . . ”, “at least two . . . ” etc., unless it becomes explicitly clear from the context or the specific text that only “exactly one . . . ”, “exactly two . . . ” etc. can be intended here. Furthermore, all numerals and indicated process parameters and/or device parameters are to be understood in the technical sense, that is, taking into account the normal tolerances. Also, from the explicit use of the expression “at least” or the like, it may not be concluded that if the expression “one” is used (that is, without employment of the expression “at least” or the like), “exactly one” is intended.

Advantageously, the region upstream of the nozzle has a throat which is adapted for accommodating a check valve.

In another embodiment, the check valve is a ball check valve comprising a ball closing the throat and a spring which presses the ball against the throat. The combination of ball and throat increases in particular the hydrostatic pressure. In the state of zero pressure, the ball closes the throat completely, preventing water from flowing out.

The nozzle of the cleaning device can be embodied as a fan nozzle.

In another embodiment, the cleaning device has illuminating means for at least partly illuminating the cleaning device.

The handle of the cleaning device according to the invention can have vibration means. In this manner, for example, running operation of the device can be signaled.

It is conceivable that the cleaning device further comprises a display and at least one sensor for providing an indication of a flow rate, a flow pressure and/or a filling level of the fragrance or the cleansing agent in the mixing chamber. In addition, the cleaning device can further in particular comprise a water wheel with a dynamo so as to supply current to the display and the sensor, the current being generated by the flow of water through the cleaning device.

It can be advantageous if the pipe is flexible, in particular if it is formed as a corrugated pipe.

In another embodiment, the handle and the pipe each have a connecting element for arranging, by means of the connecting elements, an elongation element between the handle and the pipe. The connecting elements within the context of the present invention can be embodied as snap-in or locking elements or alternatively as complementary threads.

In addition, at the end which is connectable to the water supply, the pipe can have a check valve and/or an AquaStop valve.

### DESCRIPTION OF THE FIGURES

In the following, the invention will be described in detail by means of examples of embodiment with reference to the Figures wherein:

FIG. 1 shows a partial cross-section of the handle and pipe according to the invention;

FIG. 2A shows a cross-section of an end portion of the pipe according to the invention in a closed state;

FIG. 2B shows a cross-section of an end portion of the pipe according to the invention in an open state;

FIG. 3 is a lateral view of the pipe according to the invention;

FIG. 4 is a cross-section of the pipe according to the invention;

FIG. 5 shows an arrangement of the cleaning device according to the invention on a toilet.

The invention will now be explained with reference to FIGS. 1 through 5 which show an advantageous embodiment.

In FIG. 5, the cleaning device 1 for cleaning toilets is shown in a connected state in which it is arranged in a retention device 8 next to a toilet. The cleaning device 1 has a hose 13 connectable to a water supply so as to provide water for the cleaning device 1 via the hose 13 (see FIG. 5).

In FIG. 5, the cleaning device 1 is connected to a water tank 9 of a toilet via a suitable water supply 7 and the hose 13, where the water supply can advantageously be embodied as a water inlet valve. According to the invention, however, connection of the cleaning device 1 to any other water supply source in the household is possible via the hose 13 and a suitable adapter.

The cleaning device 1 is advantageously made at least partly, preferably completely, of an antibacterial plastic. The cleaning device preferably has a rotationally symmetrical shape. However, elliptical or other flattened shapes are also possible according to the invention, in particular for ergonomic handling of the device.

The cleaning device 1 will now be described in more detail, first by means of FIG. 1. The cleaning device 1 has a handle 2 which is attached to the above-mentioned hose 13. Both permanent and releasable attachment are conceivable according to the invention, provided that tightness of the connection is guaranteed. The handle 2 further comprises a water regulator 5 for adjusting an inlet of water into the cleaning device 1 by means of the water regulator 5. According to the invention, an on/off-regulation is possible as well as a regulation in which the water flow rate can be adjusted. Advantageously, regulation of the water flow rate, as shown, takes place by means of two push-buttons. As shown in the Figures, the handle 2 can be embodied rotationally-symmetrical as a circular cylinder. A flattened embodiment of the handle 2 for ergonomic usage is also conceivable according to the invention.

If the handle 2 and the pipe 3 are rotationally-symmetrical along a common axis, the cleaning device 3 advantageously has sufficient length in order to deeply penetrate into the toilet that is to be cleaned.

In addition, the cleaning device 1 has a pipe 3 which is connected to the handle 2. Preferably, the connection is a tight threaded joint or a quick acting closure.

Advantageously, the pipe 3 additionally has a filtering system arranged inside the pipe 3. The filtering system divides the pipe 3 into an upstream region with a substantially constant cross-section and a downstream region 17 tapering in the downstream direction which accelerates the flow. The filtering system can comprise, for example, a sieve 10 which is preferably arranged in a sieve bed 11 for stabilization. The sieve bed 11 advantageously also allows replacement of the sieve 10, if desired. The upstream region of the pipe 3 forms a mixing chamber 6 for receiving a fragrance or a cleansing agent, and the downstream region 17 of the pipe 3 is adapted to accelerate the fragrance or the cleansing agent mixed with water. The filtering system is advantageous since particles created by dissolution of the fragrance or the cleaning agent are collected and therefore do not clog the downstream region of the pipe 3, in particular a nozzle as described below and/or a check valve as described below.

The downstream region further has a nozzle 12 at its outlet. The nozzle 12 is formed e.g. as a fan nozzle.

The downstream region has a throat 14 upstream of the nozzle 12, the throat 14 being adapted for receiving a check valve. The check valve can be embodied as a ball check valve as shown in FIGS. 1, 2A, 2B and 4, the ball check valve having a ball 15 closing the throat 14 and a spring 16, with the spring 16 pressing the ball 15 against the throat 14. Advantageously, the ball 15 and/or the spring 16 can be made of silicone.

The combination of the ball 15 and the throat 14 in particular increases the hydrostatic pressure. In the state of zero pressure, the ball 15 closes the throat 14 completely, preventing water from flowing out or in. FIG. 2A shows this zero-pressure state whereas in FIG. 2B, there is water pressure so that water bypasses the ball 15 and is delivered from the nozzle 12.

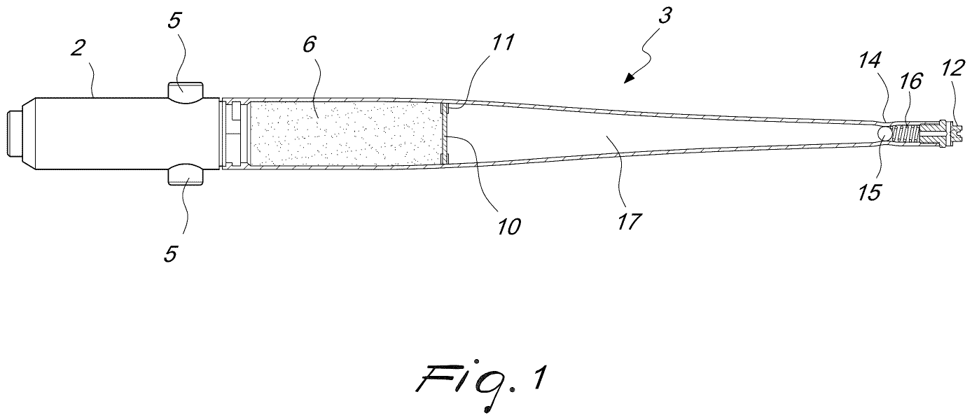

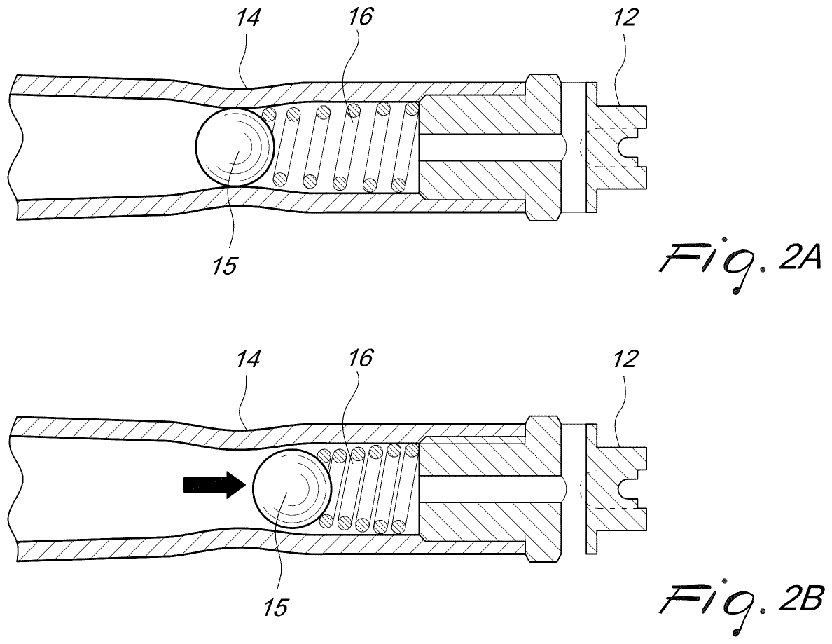

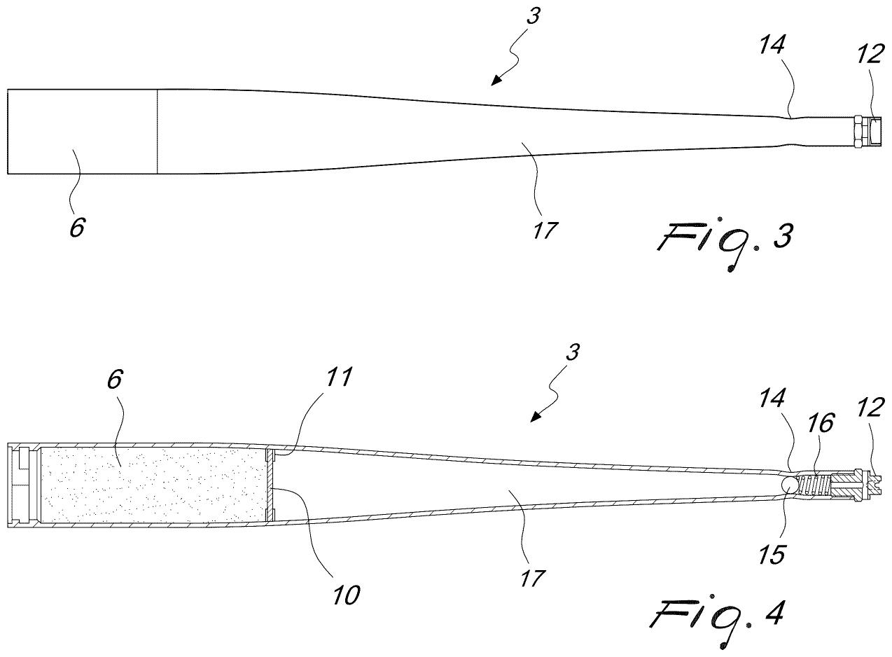

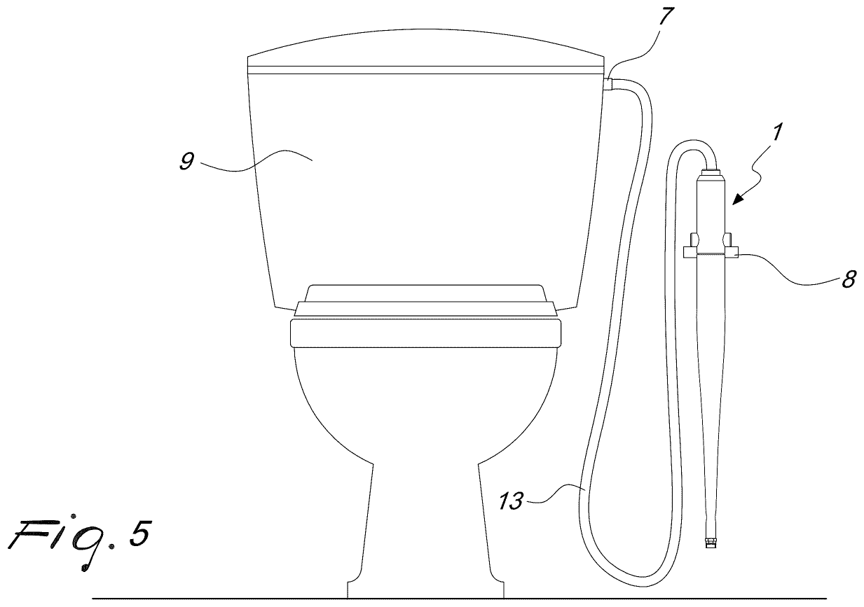

FIG. 4 shows a sectional view of the pipe 3. There, it can be seen in particular that the mixing chamber 6 is located at the end facing the handle 2. Fragrances or cleansing agents can be introduced into the mixing chamber 6 as desired in order to mix them with the water flowing through it. In the embodiment according to FIG. 4, the sieve 10 is arranged downstream of the mixing chamber 6, which sieve is positioned in a sieve bed 11 for stabilization.

Within the context of the invention, it is conceivable that the cleaning device 1 has illumination means in order to at least partly illuminate the cleaning device 1, which, however, is not shown in the Figures.

The handle 2 of the cleaning device 1 according to the invention can also comprise vibration means. In this way, running operation of the device and/or a lack of fragrance or cleansing agent, for instance, can be signaled. Also, better mixing of a solid fragrance or cleansing agent with the water passing through it is made possible by the vibration generated by the vibration means.

It is also conceivable that in an embodiment not shown in the Figures, the cleaning device 1 also has a display and at least one sensor for indicating a flow rate, a flow pressure and/or a filling level of the fragrance or cleansing agent in the mixing chamber 6. In addition, the cleaning device 1 can in particular also comprise a water wheel with a dynamo in order to supply the display and the sensor with current, the current being generated by a water flow through the cleaning device 1.

It can be advantageous if the pipe 3 is flexible, in particular a corrugated pipe.

In another possible embodiment, which is not shown, the handle 2 and the pipe 3 each have a connecting element by means of which an elongation element can be arranged between the handle 2 and the pipe 3. It is also conceivable to provide one single connecting element. The pipe 3 can preferably also comprise an elongation element between the downstream end of the pipe 3 and the nozzle 12 so that the nozzle 12 can reach into additional areas of the toilet.

The connecting element(s) within the context of the present invention can be embodied as snap-in or locking elements, or alternatively as complementary threads.

The hose 13 can additionally comprise, at the end which is connectable to the water supply, a check valve and/or an AquaStop valve.

Advantageously, the cleaning device according to the invention works by means of the high water pressure, which completely obviates the need for urine residue remover. If desired, a fragrance and/or cleansing agent can be filled in the mixing chamber 6 inside the cleaning device 1. The invention is a clearly more hygienic toilet bowl cleaning device than the conventional toilet brush. The novel toilet cleaning device is operated by water pressure and allows thorough and hygienic cleaning without bristles and contamination.

Also, the cleaning device 1 according to the invention is free from a brush container as it is known from toilet cleaning brushes. Consequently, no more germs and bacteria accumulate in unhygienic toilet brush containers. Additionally, the cleaning device is in particular made of antibacterial plastics so that the adhesion of germs and bacteria can also be prevented in this manner.

Furthermore, the toilet cleaning device counteracts the generation of large amounts of waste.

It is also critical to mention that other than with a conventional toilet brush, the acquisition costs are one-time costs.

The cleaning device 1 is preferably connected to an existing water inlet valve of a water tank 9, in particular by means of a distributor (T-piece), and can be attached to a wall or to the water tank 9 by means of a retention device 8. Inside the cleaning device 1, there is the mixing chamber 6 for mixing the water with fragrances and/or cleansing agents. This innovative system allows in the first place germ-free cleaning with the cleaning device 1 and has the advantage that other than with traditional toilet brushes, no germs and bacteria adhere to the toilet cleaning device 1 and therefore are neither distributed nor multiply.

The functioning method of the invention is preferably as follows:

The water is conveyed via the hose 13 and then through the handle 2 into the mixing chamber 6 of the pipe 3 and is mixed with the fragrances and/or cleansing agents. Then the mixture is filtered through the sieve 10 of a filtering system and is thus freed from residues so as not to clog the nozzle 12. For additional stability, the sieve 10 is supported by a sieve bed 11. Now the fluid or water, respectively, flows into the throat 14 of the pipe 3, where the flow rate decreases due to the presence of the throat 14, causing the hydrostatic pressure to increase. This process step comprises an additional technology which prevents uncontrolled dripping at rest. The tip of the pipe 3 preferably accommodates the ball 15, for instance a silicone ball, with resistance being exerted by the pressure spring 16 which in the condition at rest closes the pipe 3 in the region of the throat 14, preventing dripping. If the water regulator 5 is now operated, the hydrostatic pressure increases, causing the ball 15, in particular the silicone ball, to be pressed in the direction of the spring 16, in turn causing the water to issue from the nozzle 12.

Although the invention has been described in connection with water, it can also be used in connection with another similar liquid or fluid. Also, the invention can be employed with water at a pressure existing in conventional water pipes as well as with overpressure. In any case, the velocity and/or pressure of the issuing water jet are increased by the form of the cleaning device 1 according to the invention.

The toilet cleaning device 1 has been developed with maximum precision in order to be able to achieve maximum hygiene. In an advantageous embodiment, the length of the device is approximately 50 cm (pipe 3 approx. 40 cm; handle 2 approx. 10 cm) so as to allow hygienically safe spacing during use.

The embodiments shown here are only examples illustrating the present invention and are therefore not to be intended as limiting. Alternative embodiments considered by the person skilled in the art are equally comprised by the scope of protection of the present invention.

### LIST OF REFERENCE NUMBERS

1 cleaning device
2 handle
3 pipe
5 water regulator
6 mixing chamber
7 water supply water inlet valve
8 retention device
9 water tank
10 sieve
11 sieve bed
12 nozzle
13 hose
14 throat
15 silicone ball
16 pressure spring
17 tapering region of pipe 3

1. Cleaning device for cleaning toilets, the cleaning device at last partly, preferably completely, consisting of antibacterial plastics, wherein the cleaning device has the following features:
a hose connectable to a water supply in order to supply water for the cleaning device via the hose,
a handle fastened to the hose, the handle further comprising a water regulator for adjusting an inlet of water into the cleaning device by means of the water regulator,
a pipe arranged downstream on the handle, the pipe having a filtering system arranged inside the pipe, the filtering system dividing the pipe into an upstream portion with a substantially constant cross-section and a downstream portion tapering in the downstream direction, the upstream portion of the pipe forming a mixing chamber for receiving a fragrance or a cleansing agent and the downstream portion of the pipe being adapted to accelerate the water issuing from the mixing chamber,
the downstream portion having a nozzle at its outlet, and
the handle and the pipe being formed rotationally-symmetrical along a common axis.

2. Cleaning device according to claim 1, the downstream portion of the pipe having a throat with a check valve upstream of the nozzle, the throat being adapted for accommodating the check valve.

3. Cleaning device according to claim 2, the check valve being embodied as a ball check valve, the ball check valve having a ball closing the throat and a spring, the spring pressing the ball against the throat.

4. Cleaning device according to claim 1, the nozzle being embodied as a fan nozzle.

5. Cleaning device according to claim 1, the cleaning device having illumination means for at least partly illuminating the cleaning device.

6. Cleaning device according to claim 1, the handle having vibration means.

7. Cleaning device according to claim 1, the cleaning device further having a display and at least one sensor for providing an indication of a flow rate, a flow pressure and/or a filling level of the fragrance or the cleansing agent in the mixing chamber,
the cleaning device further in particular comprising a water wheel with a dynamo so as to supply current to the display and the sensor, the current being generated by a flow of water through the cleaning device.

8. Cleaning device according to claim 1, the pipe being flexible, in particular formed as a corrugated pipe.

9. Cleaning device according to claim 1, the handle and/or the pipe having at least one connecting element for arranging an elongation element between the handle and the pipe by means of the at least one connecting element, and/or the pipe having an elongation element between the downstream end of the pipe and the nozzle.

10. Cleaning device according to claim 1, the hose having a check valve and/or an AquaStop at the end which is connectable to the water supply.

11. Cleaning device according to claim 1, the filtering system comprising a sieve arranged in a sieve bed.

12. Cleaning device according to claim 1, the handle being a circular cylinder and/or the pipe having an upstream portion formed like a circular cylinder which is followed downstream by one formed like a truncated cone.
